(19) United States
(12) Patent Application Publication
(10) Pub. No.: US 2011/0188188 A1
(43) Pub. Date: Aug. 4, 2011

(54) SERVER ASSEMBLY

(75) Inventor: HAI-LONG ZHANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/852,478

(22) Filed: Aug. 7, 2010

(30) Foreign Application Priority Data
Feb. 1, 2010 (CN) 201020302054.0

(51) Int. Cl. G06F 1/16

(52) U.S. Cl. 361/679.02

(57) ABSTRACT

A server assemble includes a server rack, a server, and a mounting member configured to mount the server to the server rack. The server rack includes a first support disposed in the server rack and a second support disposed adjacent to the first support. The server includes a side plate, and the server is located between the first support and the second support. The mounting member is secured to the side plate, wherein the mounting member is mounted to the first support of the server rack.

### BACKGROUND

1. Technical Field

The present disclosure relates to a server assembly for mounting a server to a server rack.

2. Description of Related Art

There are a large number of servers mounted in a typical, server rack. The servers could be a power distribution module, a power switch, or a rack control module. The power distribution module is capable of offering a number of sockets. The power switch is capable of offering many switches. The rack control module is capable of controlling the system in the rack. Usually, there is some extra space in the back of the server rack. If not used, this space is wasted.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partially, exploded view of a server assembly in accordance with an embodiment.

FIG. 2 is similar to FIG. 1, but viewed from a different aspect.

FIG. 3 is an assembled view of the server assembly shown in FIG. 1.

FIG. 4 is an assembled view of a server, a mounting member and a server rack.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

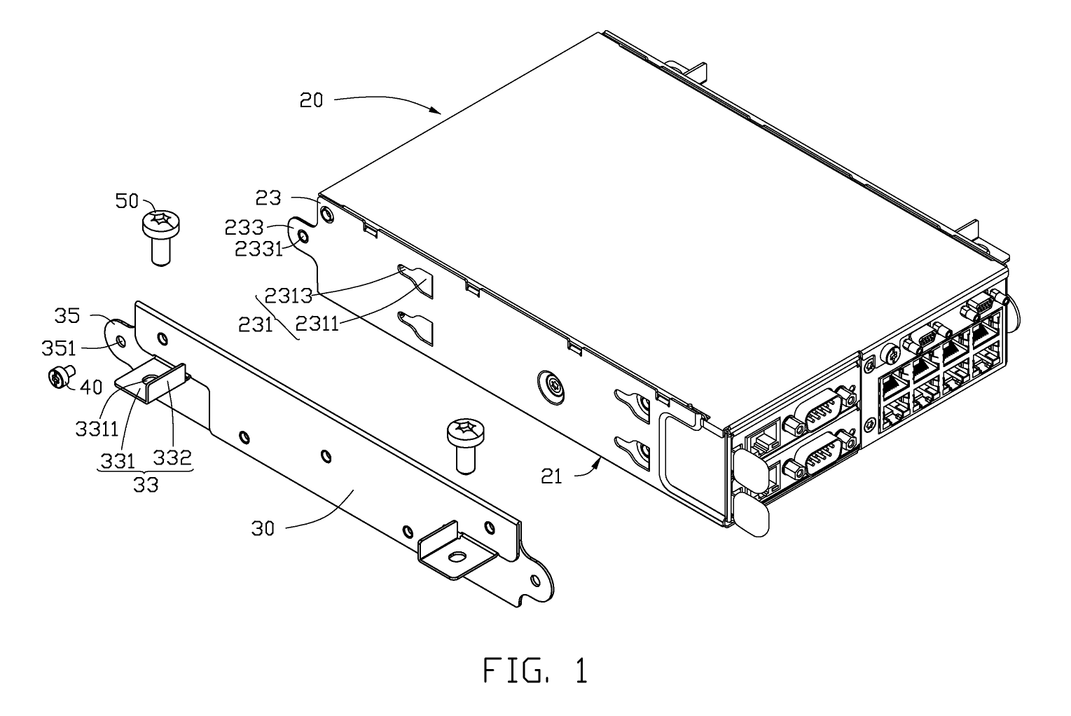

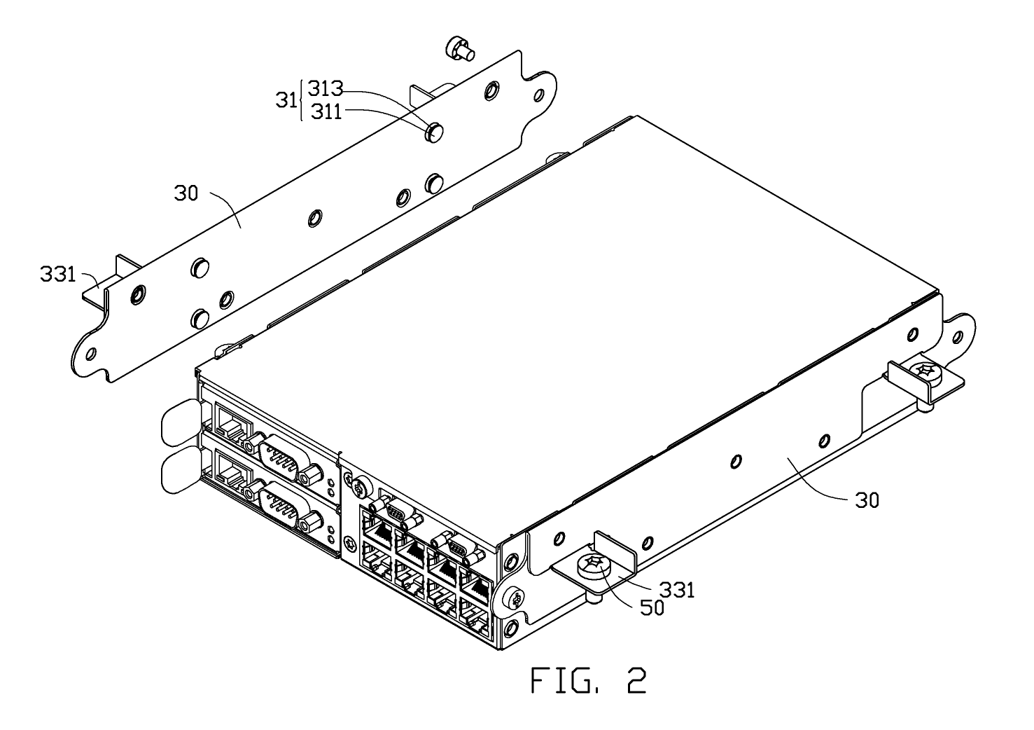

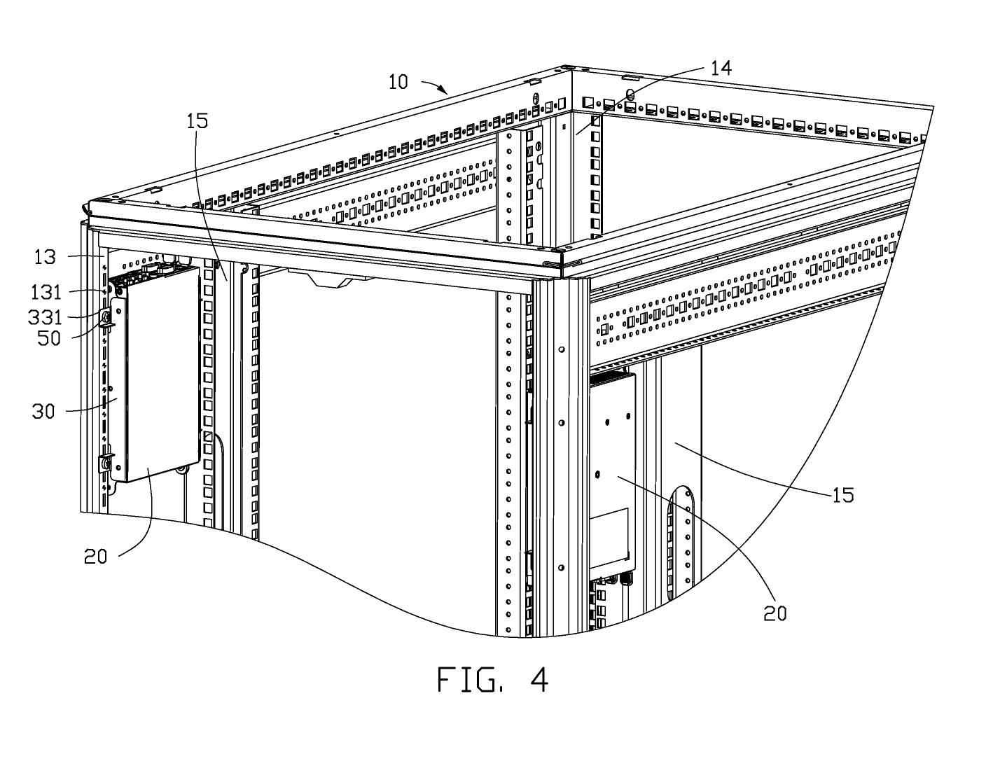

Referring to FIGS. 1 and 2, a server assembly in accordance with an embodiment includes a server rack 10 (shown in FIG. 4), a server 20 mounted on the server rack 10, and two mounting members 30 mounted on two opposite sides of each server 20.

Referring to FIG. 4, the server rack 10 includes two first supports 13 located in the back of the server rack 10, four second supports 15, and two third supports 14 located in the front of the server rack 10. In one embodiment, each first support 13 is upright and substantially parallel to each third support 14, and each second support 15 is adjacent to each first support 13. A plurality of screw holes 131 is defined in the first support 13.

Referring to FIGS. 1 and 2, the server 20 includes a bottom plate 21 and two side plates 23 perpendicular to the bottom plate 21. Four positioning slots 231 are defined in each side plate 23. In one embodiment, each positioning slot 231 includes a guiding portion 2311 and a positioning portion 2313 communicating with the guiding portion 2311. The guiding portion 2311 is bigger than the positioning portion 2313. A screw portion 233 extends from an edge of each side plate 23. A mounting hole 2331 is defined in the screw portion 233. In one embodiment, the server 20 can be a power distribution module, or a rack distribution module.

Four positioning posts 31 protrude from one side of each mounting member 30, corresponding to the positioning slots 231 of the side plate 23. The positioning post 31 is capable of engaging in the position slot 231 to secure the mounting member 30 to the side plate 23 of the server 20. Two securing portions 33 are disposed on another side of each mounting member 30. Each positioning post 31 includes a head 311 and a neck 313 having a diameter less than that of the head 311. The size of the head 311 is less than the size of the guiding portion 2311, but lager than the size of the positioning portion 2313. The head 311 is capable of sliding into the positioning portion 2313, to make the neck 313 position in the positioning portion 2313.

The securing portion 33 includes a securing piece 331 located on the side mounting member 30, and a flange 332 extending substantially perpendicular from the securing piece 331. In one embodiment, the securing piece 331 is substantially perpendicular to the side mounting member 30. A securing hole 3311 is defined in the securing piece 331, corresponding to the screw hole 131 of the first support 13. A fixing portion 35 extends from on an edge of the mounting member 30. A fixing hole 351 is defined in the fixing portion 35, corresponding to the mounting hole 2331 in the screw portion 233. In one embodiment, the length of the mounting member 30 is approximately equal to the length of the side plate 23 of the server 20.

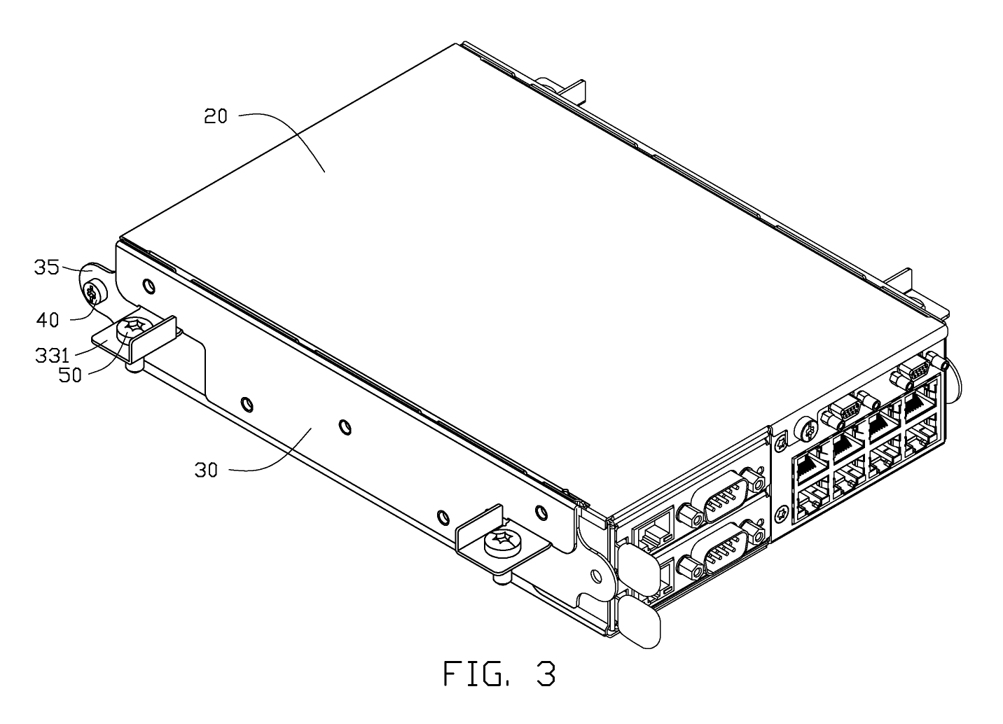

Referring to FIG. 3, in assembly, the head 311 of each positioning post 31 is slid into the positioning portion 2313 from the guiding portion 2311, and the neck 313 of each positioning post 31 is inserted in the positioning portion 2313. The fixing hole 351 of the fixing portion 35 is aligned with the mounting hole 2331 of the screw portion 233. A fixing member 40, such as a screw, is screwed into the fixing hole 351 and the mounting hole 2331, to mount the mounting member 30 to the side plate 23.

Referring to FIG. 4, the server 20 and the mounting member 30 are placed in the back of the server rack 10 between a first support 13 and a second support 15. The screw holes 131 of the first support 13 are aligned with the securing holes 3311 of the securing piece 331 on one mounting member 30. Two screw members 50, such as screws, are screwed into the screw holes 131 and the securing holes 3311, to mount the first support 13 to the one mounting member 30.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A server assembly, comprising:
a server rack comprising a first support, located on the server rack, and a second support, located on the server rack;
a server, located between the first support and the second support, comprising a side plate, and
a mounting member secured to the side plate;
wherein the mounting member is mounted to the first support of the server rack.

2. The server assembly of claim 1, wherein the length of the mounting member is substantially equal to the length of the side plate.

3. The server assembly of claim 1, wherein a securing portion is disposed on the mounting member, and the securing portion is secured to the first support.

4. The server assembly of claim 3, wherein the securing portion comprises a securing piece, and the securing piece is substantially perpendicular to the mounting member.

5. The server assembly of claim 4, wherein the securing portion further comprises a flange connected to the securing piece, and the flange is substantially perpendicular to the securing piece.

6. The server assembly of claim 3, wherein a positioning post protrudes from the mounting member, and a positioning slot is defined in the side plate corresponding to the positioning post.

7. The server assembly of claim 6, wherein the positioning post comprises a head and a neck connected to the head, and the diameter of the neck is less than that of the head.

8. The server assembly of claim 6, wherein the positioning post is located on one side of the mounting member, and the securing portion is located opposite side of the mounting member.

9. The server assembly of claim 1, wherein a screw portion extends from the side plate, and a fixing portion extends from the mounting member, corresponding to the screw portion.

10. The server assembly of claim 1, wherein the server is a power distribution module.

11. A server assembly comprising:
a server rack comprising a first support, disposed in the server rack, and a second support, disposed adjacent to the first support;
a server located between the first support and the second support;
a mounting member mounted to the server, and a securing portion disposed on the mounting member, wherein the securing portion is mounted to the first support.

12. The server assembly of claim 11, wherein the server comprises a side plate, and the length of the side plate is substantially equal to the length of the mounting member.

13. The server assembly of claim 11, wherein the securing portion comprises a securing piece, and the securing piece is substantially perpendicular to the mounting member.

14. The server assembly of claim 13, wherein the securing portion comprises a flange connected to the securing piece, and the flange is substantially perpendicular to the securing piece.

15. The server assembly of claim 12, wherein a positioning post is protruded on the mounting member, and a positioning slot is defined in the side plate corresponding to the positioning post.

16. The server assembly of claim 15, wherein the positioning post protrudes from on one side of the mounting member, and the securing portion is disposed on another opposite side of the mounting member.

17. The server assembly of claim 15, wherein the positioning post comprises a head and a neck positioned in the positioning slot, and the diameter of the neck is less than that of the head.

18. The server assembly of claim 12, wherein a screw portion extends from an edge of the side plate, and a fixing portion extends from an edge of the mounting member, corresponding to the screw portion.

19. The server assembly of claim 11, wherein the server is a power distribution module.
